(19) United States
(12) Patent Application Publication
(10) Pub. No.: US 2003/0008036 A1
(43) Pub. Date: Jan. 9, 2003

(54) Method of using wood chips in brewing malt beverages

(76) Inventors: Nick J. Huige, Brookfield, WI (US); John R. Seabrooks, Richfield, WI (US); David S. Ryder, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 09/812,349

(22) Filed: Mar. 20, 2001

(51) Int. Cl. C12C 11/00

(52) U.S. Cl. 426/16

(57) ABSTRACT

A process is disclosed whereby wood chips are used in the brewing process to produce a beer which is more pleasing and mellow than conventional beers. The wood chips are preferably toasted oak chips.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to brewing. More particularly, it relates to a method of brewing malt beverages using wood chips. The wood chips are preferably toasted oak chips.

2. Background of the Art

Wood and its effects on flavor have been well known in the wine and distilled beverage industries for hundreds of years. Many wines and distilled spirits are dependent on the flavors, balance, and round mellowness that can only come from aging or maturation in the presence of wood.

Many wines and distilled spirits are now aged or matured in oak casks. For a general discussion of the wood maturation of distilled beverages and the construction of casks see Mosedale, et al., “Wood Maturation of Distilled Beverages”, Trends in Food Science and Technology Vol. 9 (1998), pages 95-101. The disclosure of all of the above articles, and of all other articles and patents recited herein, are incorporated by reference as if fully set forth herein.

The mechanism of the maturation of distilled spirits in oak casks is complex but has become better understood in recent years. For example, some recent research indicates that part of the maturation process involves the extraction of wood components into the distilled spirit which increases the solubility of certain esters in the aqueous ethanol thereby decreasing their volatility and hence their head space concentrations. This in turn changes the aroma of the matured spirit. See, for example, J. Piggott, et al., “The Influence of Non-volatile Constituents on the Extraction of Ethyl Esters from Brandies”, J. Sci. Food Agric., Vol. 59 (1992), pages 447-482; Connor, “Role of Organic Acids in Maturation of Distilled Spirits in Oak Casks”, J. Inst. Brew., Vol. 105, No. 5 (1994), pages 287-291; and Connor, et al., “Agglomeration of Ethyl Esters in Model Spirit Solutions and Malt Whiskies”, J. Sci. Food Agric., Vol. 66 (1994), pages 45-53.

Several researchers have also disclosed the use of oak extracts to either replace or supplement the maturation of distilled spirits in oak casks. See Piggott, et al., supra. For a discussion of the preparation of and chemical composition of commercial oak wood extracts see J. Puech, et al., “Principles of Preparation and Chemical Composition of Commercial Oak Wood Extracts”, in Flavors and Off Flavors '89, (G. Charalambous, Editor) pages 159-167, Elsevier Science, Amsterdam (1989).

Oak wood chips have also been suggested for the maturation of wines and distilled spirits. See, for example, Mosedale, et al., supra and Puech, et al., supra.

Much research activity has also been directed to the flavors and aromas found in beer. For example, the flavor thresholds of compounds in beer are discussed in Gardner, et al., “Application of Property-Activity Relationships and Structure-Activity Relationships to Flavour Research”, MBAA Technical Quarterly, Vol. 16 (1979), pages 148-156. Many factors affect the flavors and aromas found in beer including, for example, the type of hops used and the fermentation conditions. It has also been proposed to age or mature beer in oak casks, including casks previously used to mature distilled spirits and wines. See Allen, “I, Beer Thrall, Waiting for Wood”, American Brewer, Vol. 77 (1998), pages 38-39. Allen also discloses adding oak chips to a conditioning tank to age the beer.

In a process unrelated to maturing or aging beer, U.S. Pat. No. 4,329,918 discloses the use of small bodies, including wood, to collect precipitates found in foam during the fermentation process and to protect the beer from undue contact with oxygen.

For a detailed discussion of the art of brewing see Vogel, Jr., et al., The Practical Brewer, Master Brewers Association of America, Von Hoffmann Press, St. Louis, MO (1947).

As discussed above, there is a recognition that maturing or aging beer in the presence of oak barrels or chips provides certain desirable flavor characteristics to the beer. However, one drawback is that the oak chips and/or barrels must be disinfected to prevent spoilage of the beer during the aging or maturation process. Moreover, if wood chips are used these must be removed before the beer is packaged. Also, the aging of beer in wood casks is not conducive to the requirements of high volume manufacturing. Accordingly, it would be useful to obtain the benefits of maturing or aging beer in the presence of wood using a process which can be easily integrated into normal brewing operations.

### BRIEF SUMMARY OF THE INVENTION

We have discovered a new process for providing certain maturation or aging characteristics to malt beverages. More specifically, this new process utilizes wood chips to provide such characteristics to the malt beverage. Preferably, the wood chips are oak chips and advantageously the wood chips are toasted. Although extracts of the wood chips may be used to impart the desired characteristics to the malt beverage, in a preferred embodiment of the invention, the wood chips are added directly to hot wort. The addition of wood chips to hot wort can be easily and advantageously integrated into normal brewing operations since sterilization of the wood chips will occur in hot wort and the wood chips can then, for example, be removed from the wort along with the trub. The wood chips can be added to the hot wort in the brew kettle or in the hot wort tank. The malt beverages made utilizing this new process possess certain desirable flavor characteristics not found in malt beverages made by conventional methods.

One aspect of the invention provides a method of brewing malt beverages comprising preparing hot wort; adding wood chips to the hot wort; and fermenting the wort to produce a fermented malt beverage.

The wood chips can be removed before or after the fermentation step. For example, if the chips settle, they can be conveniently removed along with the trub. If the wood chips float, they can be removed with screening techniques such as a hop jack. Alternatively, the wood chips can be exposed to the wort using a “tea bag” approach. For example, the wood chips can be put in a porous container which is suitable weighted, if necessary, to ensure that the wood chips are submerged in the wort.

Another aspect of the invention provides a method of brewing malt beverages comprising preparing wort; fermenting the wart in the presence of wood chips to produce a fermented malt beverage; and removing the wood chips from the fermented malt beverage.

Yet another aspect of the invention provides a method of brewing malt beverages comprising preparing hot wart; and fermenting cooled wart to produce a fermented malt beverage; wherein a water extract of wood chips is added to one of the hot wort, the cooled wort, or the fermented malt beverage.

A still further aspect of the invention provides a method of brewing malt beverages comprising preparing a mash; adding wood chips to the mash; separating wart from the mash; and fermenting the wart to produce a fermented malt beverage. Advantageously, the wood chips can be easily separated from the wart in the lauter tub.

In each of the above embodiments of the invention, it is preferred that the wood chips are either American or French oak and that they are toasted.

The objects of the invention, therefore, include providing methods of using wood chips in the brewing of malt beverages of the above type:

(a) which provide malt beverages which exhibit interesting organoleptic properties;

(b) which provide a malt beverage in which the sulphidic notes and other undesirable notes are mellowed out; and

(c) which can be easily integrated into normal brewing operations.

These and still other objects and advantages of the present invention will be apparent from the description below. However, this description is only of the preferred embodiments. The claims should, therefore, be looked to in order to assess the whole scope of the invention.

### DETAILED DESCRIPTION OF THE INVENTION

Many of the compounds responsible for contributing certain flavors and aromas to beverages when they are aged in wood casks are derived from the degraded structural macromolecules which result from heating (e.g., toasting or charring) the cask during its fabrication. See Mosedale, et al., supra. There are a number of suppliers of wood barrels and wood chips. For example, oak barrels and oak chips are available from Barrel Builders, Inc., St. Helena, Calif. Barrels and chips are typically supplied with a light, medium, or heavy toast, which can vary in color from amber to almost black. Customized toast levels are also available.

The desired size and/or configurations of the wood chips can be empirically optimized depending on the specific process parameters of the brewing process. Obviously, smaller chips (i.e., greater surface area/unit weight) will generally be easier to extract. However, the wood chips should not be so small such that the particulates generated are difficult to remove. The oak wood chips utilized in the following examples were about ¼″ to ¾″ in length (with ⅜″ being most common); about ⅛″ to ⅜″ in width (with ¼″ being most common); and about 1/16″ to 3/16″ thick (with ⅛″ being most common). Generally, wood chips in such a size range would be acceptable in most applications although other sizes and configurations would also be satisfactory depending on the parameters of the brewing process.

The following experiments were conducted to ascertain the effects certain “aging” schemes would have on the flavor characteristics of malt beverages. Specifically, various types of oak chips were utilized in a number of different ways in the course of making a pasteurized, conventional American-style lager beer.

### EXAMPLE 1

In this example, the use of four different types of oak wood chips in brewing were evaluated:

(1) American oak chips (Quercus alba) with a medium plus toast.

(2) French oak chips (Quercus robur) with a medium toast.

(3) French oak chips (Quercus robur) with a medium plus toast.

(4) French oak chips (Quercus robur) with a heavy toast.

All of the above oak chips were obtained from Barrel Builders, Inc., St. Helena, Calif.

An extract of each type of oak chip was made by autoclaving for 30 minutes at 121° C. about 100 ml water and about 13.6 g of chips in a 3 gallon cannister. Each cannister was cooled and then about 3 gallons of a conventional American-style lager beer was added to each cannister. Each cannister was then aged at 35° F. for about 7-10 days. Each beer was then bottled and pasteurized.

Each bottled beer was then subjected to a volatile analysis for the following components: acetaldehyde, propanol, ethyl acetate, isobutanol, ethyl propanoate, amyl alcohol, isoamyl alcohol, isobutyl acetate, ethyl butanoate, isoamyl acetate, diacetyl, and pentanedione. These volatile components provide certain flavor characteristics to a finished malt beverage. The same conventional American-style lager beer, but with no exposure to the oak chips, served as the control.

The volatile analysis on each sample indicated that the beer aged with medium toast French oak chips had somewhat higher fusel oils and other volatiles than the control and the other beers aged with oak chips. The beers made with medium plus toast American oak chips, medium plus toast French oak chips, and heavy toast French oak chips showed the same or slightly lower volatiles than in the control beer.

Overall, the volatile analysis of each beer showed no significant differences which was confirmed by an informal tasting of each beer by the inventors and some of their colleagues.

### EXAMPLE 2

In this example, the use of heavy toasted French oak chips in brewing were evaluated. The heavy toasted French oak chips were obtained from Barrel Builder's, Inc.

Extraction of the oak flavor was done at four different conditions and special brews were made using the following extraction schemes:

(1) aging the beer with oak chips at 37° F.

(2) aging the beer with oak chips at 75° F.

(3) high temperature water extract added to beer.

(4) high temperature water extract added to beer and aging the beer with oak chips at 37° F.

The aging period was about 2 weeks.

The oak chips and/or the high temperature extract were used in the amount (or equivalent amount in the case of the extract) of about 4.5 g/gal of beer (about 1190 ppm). The high temperature water extract was prepared in an autoclave as described in Example 1. The beer used in this experiment w a s a conventional American-style lager. All samples were filtered, bottled, and pasteurized after the aging period.

A control beer was also utilized as in Example 1 (an untreated conventional American-style lager).

Samples of the four beers and the control were submitted for sensory testing by a seven member round table panel. The panel was asked to describe the differences between the five beers. The results are summarized in Table 1.

A phenolic and spicy flavor was common to all four special brews, but with varying intensities. The brew aged with chips at 75° F. had the most phenolic flavor, while the brew aged with chips at 37° F. had the least spicy flavor. The high temperature water extract imparted more phenolic and spicy flavor than aging with chips at 37° F. alone. Both brews with high temperature water extract were fairly similar. The control had a strong sulphidic flavor which was not noted in any of the special brews.

TABLE 1

| | | | | Hight Temp. |
|---|---|---|---|---|
| | | | High Temp. | Water Extract |
| Control | Chips @ 37° F. | Chips @ 75° F. | Water Extract | and Chips @ 37° F. |
| sulphidic/burnt | phenolic | phenolic - most | phenolic | phenolic |
| rubber | slightly sulphidic | | | |
| slightly hoppy | slightly fruity | | | |
| slightly fruity | spicy/clove - less | spicy/clove | spicy/clove | spicy/clove |
| | than other three | | | |
| | oak chip brews | | | |

### EXAMPLE 3

Two pilot brews were made using heavy toasted French oak chips. The oak chips were obtained from Barrel Builders, Inc. Each brew was a conventional, American-style lager. In one brew (Brew #1), about 88 ppm of heavy toasted French oak chips (3.5 g/40 liters) were added to hot wort. After one hour in the hot wort tank, the chips and the trub were removed and then the wort was fermented and finished in a conventional manner into a final beer.

In the second brew (Brew #2), about 88 ppm of heavy toasted French oak chips were added to the cooled wort at the start of fermentation. The oak chips were autoclaved in the presence of water before their addition to the fermentation kettle to prevent contamination of the fermentation medium. The oak chips were discarded along with the yeast after the fermentation.

A third brew, as the control, was fermented and finished without the use of oak chips.

All three brews were bottled and pasteurized for use in a paired QDA comparison with the control and for a round table description. The QDA methodology is described in detail in J. McCredy, et al., Food Technology, 28, 36-41 (1974).

A seven-member round table panel evaluated the samples to profile the flavor attributes of these beers. They found all three products to be relatively similar with the control and Brew #2 being the most similar. Brew #2 was found to have some diacetyl but the panelists did not characterize this as a defect. All three products were perceived as being fruitier and less bitter than a normal production conventional American-style lager.

These products were then given to the descriptive panel in a monadic QDA test where all three samples were presented to the panel in random order. Character means were calculated and significant differences between the scores of each attribute were determined through an analysis of variance. Where significant differences were found, a multiple range test was used to differentiate means. Scores sharing a common letter are not statistically different at the 95% level. Significant differences were found in fruity/estery character and sulphidic/tic character. Brew #1 was significantly higher than the control sample in fruity/estery character and significantly lower in sulphidic/tic character than the control and Brew #2.

TABLE 2
Round Table Results

| | Brew #1 | Brew #2 |
|---|---|---|
| Control | (chips added to hot wort) | (chips added to fermentation) |
| Fruity | Fruity | Fruity/Estery |
| Sweet | Low to Moderate Bitterness | Slightly Malty |
| Dry/Astringent | Sweet | Slightly Diacetyl |
| Low to Moderate Bitterness | Dry/Astringent | Low to Moderate Bitterness |
| Sulphidic/tic | Moderate Body | Moderate Body |
| | | Dry/Astringent |
| | | Most similar to Control |

TABLE 3
ANALYSIS OF VARIANCE

| | MEAN SCORES | | | | Level of |
|---|---|---|---|---|---|
| Characteristic | Control | Brew #1 | Brew #2 | F-Value | Significance |
| Aroma Strength | 10.1 | 10.3 | 10.6 | 0.76 | NSD |
| Fruity/Estery Character | 8.0^{B} | 9.0^{A} | 8.4^{A.B.} | 4.18 | 97.8% |
| Hop Character | 7.8 | 7.9 | 7.7 | 0.14 | NSD |
| Malty/Grainy Character | 8.1 | 7.2 | 7.7 | 2.86 | NSD |
| Sulphidic/tic Character | 5.5^{A} | 4.8^{B} | 5.5^{A} | 3.18 | 95.0% |
| Diacetyl Character | 3.4 | 3.4 | 3.9 | 1.45 | NSD |
| Bitterness | 9.6 | 9.5 | 9.3 | 0.24 | NSD |
| Body | 9.9 | 10.0 | 10.2 | 0.87 | NSD |
| Aftertaste | 10.0 | 10.3 | 10.1 | 0.23 | NSD |

n = 23

### EXAMPLE 4

A larger volume brew was prepared in accordance with the procedure for Brew #1 in Tables 2 and 3 except that about 300 ppm of oak chips were added to the hot wort.

This brew was then evaluated in a consumer test which was comprised of over 200 beer drinkers. Other brews tested included other prototype beers, beers currently marketed by the assignee of the present invention, and some competitive national brand beers. Among other findings from this consumer test, the 300 ppm oak chip brew was significantly better liked than a major competitive national brand beer. The general conclusion of the consumer test was that the 300 ppm oak chip brew achieved the highest acceptance among the total test population.

Other Considerations and Embodiments

It should be understood that by hot wort we mean wort at a temperature of at least about 145° F., preferably at least about 170° F. The wort should be hot enough so that it efficiently extracts the wood chips. In the typical production environment the hot wort will be between about 190° F. and about 200° F. It should be understood that by cooled wort we mean wort which is at an acceptable temperature for fermentation.

Methods of removing particulates such as wood chips from the wort or fermentation medium are well known to those skilled in the art. For example, any wood chips which settle in the hot wort can be removed along with the trub in the hot wort setting tank or in the whirlpool. Also, centrifugal, flotation, or filtration equipment (e.g., a screen such as a hop jack) can be used to remove the wood chips which are added directly to the wort. Alternatively, the wood chips can be introduced into the wort using a “teabag” approach. For example, the wood chips can be put into a container (e.g., a bag) made of any compatible porous material and hung into the tank which holds the wort. A suitably weighted container should be used if the wood chips have a tendency to float.

Alternatively, it should be understood that we also envision adding wood chips to the brew kettle during the wort filling process. The temperature of the wort at this point will be about 170° F. or slightly below.

We further envision adding the wood chips to the mash tun or mash cooker. For these cases we would add the chips directly to the mash and they would be easily separated from the wort in the lauter tun. If one added the chips to the cooker we would have a beneficial extraction period of high temperature. However, if the chips were added to the mash, the temperature exposure would be lower as the mash is heated in steps from about 145° F. to about 170° F. We anticipate that adding chips to the mash would be a convenient way to add them since they may not have as much of a tendency to float and the use of a “teabag” would not be required.

We claim:

1. A method of brewing malt beverages comprising:
preparing a hot wort;
adding wood chips to the hot wort;
cooling the hot wort; and
fermenting the cooled wort to produce a fermented malt beverage.

2. The method of claim 1, wherein the wood chips are added to the hot wort in a brew kettle.

3. The method of claim 1, wherein the wood chips are removed from the wort before the fermentation step.

4. The method of claim 1, wherein the wood chips are removed after the fermentation step.

5. The method of claim 1, wherein the wood chips are oak.

6. The method of claim 5, where in the oak is American oak.

7. The method of claim 5, wherein the oak is French oak.

8. The method of claim 1, wherein the wood chips are toasted.

9. The method of claim 5, wherein the oak chips are toasted.

10. A method of brewing malt beverages comprising:
preparing a wort;
fermenting the wort in the presence of wood chips to produce a fermented malt beverage; and
removing the wood chips from the fermented malt beverage.

11. The method of claim 10, wherein the wood chips are oak.

12. The method of claim 11, wherein the oak is American oak.

13. The method of claim 11, wherein the oak is French oak.

14. The method of claim 10, wherein the wood chips are toasted.

15. The method of claim 11, wherein the oak chips are toasted.

16. A method of brewing malt beverages comprising:
preparing a hot wort;
cooling the hot wort; and
fermenting the cooled wort to produce a fermented malt beverage;
wherein a water extract of wood chips is added to one of the hot wort, the fermentation step, or the fermented malt beverage.

17. The method of claim 16, wherein the wood chips are oak.

18. The method of claim 17, wherein the oak is American oak.

19. The method of claim 17, wherein the oak is French oak.

20. The method of claim 16, wherein the wood chips are toasted.

21. The method of claim 17, wherein the oak chips are toasted.

22. A method of brewing malt beverages comprising:
preparing a mash;
adding wood chips to the mash;
separating wort from the mash; and
fermenting the wort to produce a fermented malt beverage.

23. The method of claim 22, wherein the wood chips are added to the mash in a mash tub or a cooker.

24. The method of claim 22, wherein the wood chips are removed from the mash in the separation step.

25. The method of claim 22, wherein the wood chips are oak.

26. The method of claim 25, wherein the oak is American oak.

27. The method of claim 25, wherein the oak is French oak.

28. The method of claim 22, wherein the wood chips are toasted.

29. The method of claims 25, wherein the oak chips are toasted.
